(19) United States
(12) Patent Application Publication
(10) Pub. No.: US 2006/0280186 A1
(43) Pub. Date: Dec. 14, 2006

(54) All IP network with server for dynamically downloading management policies to diverse IP networks and converged IP communication units

(75) Inventors: Alan Gerald Carlton, Mineola, NY (US); Narayan Parappil Menon, Syosset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/261,343

(22) Filed: Oct. 28, 2005

Related U.S. Application Data
(60) Provisional application No. 60/689,462, filed on Jun. 10, 2005.

(51) Int. Cl. H04L 12/56

(52) U.S. Cl. 370/395.52

(57) ABSTRACT

An all Internet protocol (IP) network is disclosed. The all IP network includes an application server autonomous access (ASAA) server having a management policy database, a plurality of diverse IP networks and at least one converged IP communication unit. The ASAA server downloads a plurality of different management policies to respective ones of the diverse IP networks and the converged IP communication unit based on events associated with the converged IP communication unit and the diverse IP networks, such as changes in the location of the converged IP communication unit.

### CROSS REFERENCE TO RELATED APPLICATION

This application claims the benefit of U.S. provisional application No. 60/689,462 filed Jun. 10, 2005, which is incorporated by reference as if fully set forth.

### FIELD OF INVENTION

The present invention is related to the management of a plurality of diverse Internet protocol (IP) networks and at least one converged IP communication unit supports at least two communication protocols, each of which is associated with a different type of IP network. More particularly, the present invention is related to a server which downloads management policies to the IP networks and the converged IP communication unit based on events associated with the IP networks and the converged IP communication unit.

### BACKGROUND

Current wireless technology supports network management in the context of individual wireless communication networks. Individual wireless access systems, such as those which implement the global standard for mobile communications (GSM) or wideband code division multiple access (WCDMA), provide network management features and platforms for control of their wireless access network elements.

Many different types of wireless communication networks are being deployed in today's conventional wireless communication systems including GSM, code division multiple access 2000 (CDMA2000), WCDMA, IEEE 802.11-based networks, or the like. Each type of network is managed by its own network management platform. There is, at best, a limited integration of network management support across multiple wireless communication networks. Thus, coordination of radio and network planning/configuration across diverse wireless communication networks is not provided.

### SUMMARY

The present invention is related to an all IP network. The all IP network includes an application server autonomous access (ASAA) server having a management policy database, a plurality of diverse IP networks and at least one converged IP communication unit. The ASAA server downloads a plurality of different management policies to respective ones of the diverse IP networks and the converged IP communication unit based on events associated with the converged IP communication unit and the diverse IP networks, such as changes in the location of the converged IP communication unit.

### BRIEF DESCRIPTION OF THE DRAWING

A more detailed understanding of the invention may be had from the following description, given by way of example and to be understood in conjunction with the accompanying drawing wherein:

FIG. 1 shows an all IP network which is configured to operate in accordance with the present invention.

### DETAILED DESCRIPTION OF THE PREFERRED EMBODIMENTS

Hereafter, the terminology “converged IP communication unit” includes, but is not limited to, a wireless transmit/receive unit (WTRU), a user equipment (UE), a mobile station, a fixed or mobile subscriber unit, a pager, or any other type of device capable of operating in a wireless environment.

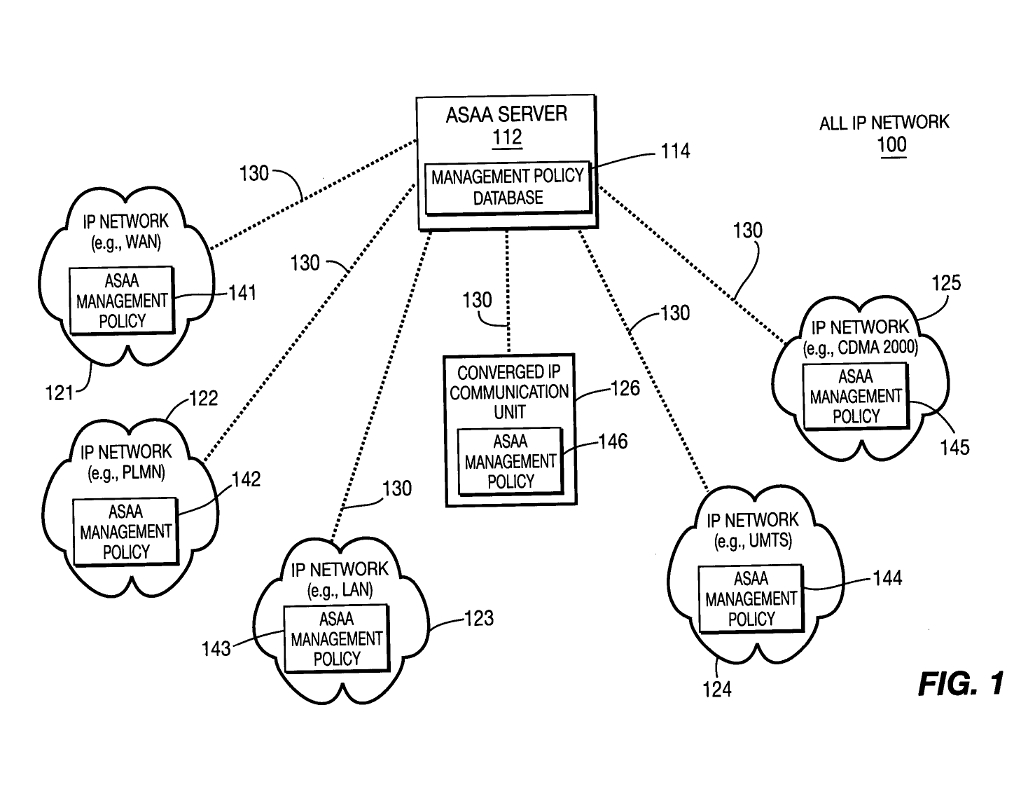

FIG. 1 shows an all IP network 100 which is configured to operate in accordance with the present invention. The all IP network 100 includes a plurality of diverse IP networks 121-125, an ASAA server 112 and at least one converged IP communication unit 126. Although it is not explicitly shown in FIG. 1, all of the IP networks 121-125 and the converged IP communication unit 126 are capable of communicating directly with an IP independent of the ASAA server 112.

The diverse IP networks 121-125 and the converged IP communication unit 126 are configured to communicate with the ASAA server 112 via wireless communication links 130. The ASAA server 112, the IP networks and the converged IP communication unit 126 are IP nodes of the all IP network 100.

The diverse IP networks 121-125 may include, for example, a wide area network (WAN) 121, a public land mobile network (PLMN)) 122, a local area network (LAN) 123, a universal mobile telecommunications system (UMTS) network 124 and a CDMA 2000 network 125. The diverse IP networks 121-125 may also include a network implemented by Bluetooth™, IEEE 802.11 x, IEEE 802.15, ZigBee or the like.

The diverse IP networks 121-125 support IP connectivity and include an entity, (i.e., a processor and/or memory), to which an ASAA management policy 141-146 can be downloaded to from management policy database 114 in the ASAA server 112. The diverse IP networks 121-125 may include supporting servers, an authentication device, security nodes, or the like.

The converged IP communication unit 126 supports at least two communication protocols, each of which is associated with a different type of IP network. The converged IP communication unit 126 is preferably enabled with a session initiation protocol (SIP). A handover function may be provided in the diverse IP networks 121-125 and the converged IP communication unit 126 such that, as the converged IP communication unit 126 moves from one network to another, a handover may occur seamlessly.

The function of the ASAA server 112 is to provide tailored and personalized management functions to the diverse networks 121-125 and the converged IP communication device 126. Management of conventional networks is provided in a static manner such that users are provided with whatever the service provider offers or what the user configures on the user's own communication device. The present invention provides custom management functionality both at the converged IP communication unit 126 and at the diverse IP networks 121-125.

In accordance with the present invention, the ASAA server 112 includes a management policy database 114 which includes ASAA management policies 141-146 that may be downloaded to the diverse IP networks 121-125 and to the converged IP communication unit 126, respectively. Alternatively, the ASAA management policies 141-146 may be maintained in an auxiliary device, such as a personal computer (PC) or auxiliary processor/database that is accessible by the diverse IP networks 121-125 and the converged IP communication unit 126. Components in the management policies 141-146 operate alone or in conjunction with the ASAA server 112.

Since all of the diverse IP networks 121-125 are connected to the ASAA server 112, it is possible for the converged IP communication unit 126 and the diverse IP networks 121-125 to maintain a one-on-one relationship with the ASAA server 112. As the converged IP communication unit 126 roams between different ones of the diverse IP networks 121-125, different management policies 141-146 are dynamically downloaded to the converged IP communication unit 126 and/or the diverse IP networks 121-125.

The management policies 141-146 define procedures and behaviors mandated in the diverse IP networks 121-125 and possibly in the converged IP communication unit 126 while roaming in the all IP network 100. The management policies 141-146 may include aspects relating to subscription handling, fault handling, device and network configuration, quality of service levels, user priorities, security and privacy.

The user of the converged IP communication unit 126 and the provider of the ASAA server 112 may provide inputs into the management policies 141-146. The management policies 141-146 may be quite different in many different scenarios that a particular user is involved in. For example, a user may feel comfortable, (i.e., safe), in their home network, resulting in a more relaxed security and privacy policy in comparison to that applied while roaming in an unfamiliar or less trusted network. A management policy may mandate a higher relative QoS or priority, (over other users of the same network), in one diverse IP network as opposed to another. A user may require the entire configuration of their communication device to be different, based upon different networks that they interact with. This device configuration may be downloaded by the ASAA server 112, or a download may be automatically triggered by the ASAA server 112 upon detecting the presence of the converged IP communication unit 126 in a particular one of the diverse IP networks 121-125.

The ASAA server 112 may modify the management policies 141-146 within a range in response to the centralized view of its position in the hierarchy allowed. For example, in a network where more than one Converged IP communication unit 126 is registered for service, it may be necessary for the ASAA server 112 to modulate the ideal management policy demanded by each user in order to allow a reasonable level of service to all users supported by the ASAA server 112 for a particular one of the diverse IP networks 141-146.

In this manner, different management policies may be applied in the diverse IP networks 121-125 and the converged IP communication unit 126, depending upon characteristics of the converged IP communication unit 126, (e.g., location, presence, behavior, or the like.

The ASAA server 112 registers for events, (such as location, proximity, behavior, or the like), which is input from the diverse IP networks 121-125 and the converged IP communication unit 126. A certain event triggers the download of a management policy 141-146 from the ASAA server 112 to the diverse networks 121-125 and/or the converged IP communication unit 126. Location, presence, behavior and other contexts may be identified by entities available to the ASAA server 112, as know to one of ordinary skill in the art. For example, upon detection of a triggering location event, the ASAA server 112 may download a particular configuration management policy, (e.g., use a WLAN in a particular area because it provides the best rate), or a particular security policy, (e.g., do not engage in a specific level of communications on a particular one of the IP networks 121-125 unless certificates are guaranteed by a certificate authority, and voice communications are acceptable but only via an IP link via a home office network, or the like.)

The common platform provided by the all IP network 100 allows for subscriber management functions, (such as activation/deactivation of subscription, accounting, billing, or the like), to be consolidated via the ASAA server 112. Furthermore, operation, administration and maintenance (OA&M) billing platforms may be connected to the ASAA server 112. Housekeeping activities, such as memory backup, restoration or upgrades, as applied to the converged IP communication unit 126, may be managed from the same single management point. Device-specific configurations, (e.g., access control, user preferences, security configuration), may also be managed from a single point.

In accordance with the present invention, the ASAA server 112 provides management of the diverse IP networks 121-125 and the converged IP communication unit 126. Network management capabilities include, but are not limited to, ASAA device/subscriber management, fault management, radio/frequency planning coordination between the diverse IP networks 121-125, and automatic network selection configurations. The ASAA device/subscriber management within the diverse IP networks 121-125 includes, but is not limited to, access control, (e.g., parental controls used in a home network), user preferences, security management, system management functions, (e.g., backup/archive, upgrades, housekeeping functions), and subscriber management, (such as activation/deactivation of subscriptions, accounting, billing, or the like). End-to-end communication mechanisms can be standard-based, (e.g., simple network management protocol (SNMP)).

Although the features and elements of the present invention are described in the preferred embodiments in particular combinations, each feature or element can be used alone without the other features and elements of the preferred embodiments or in various combinations with or without other features and elements of the present invention.

What is claimed is:

1. An all Internet protocol (IP) network comprising:
(a) a server including a management policy database;
(b) a plurality of diverse IP networks; and
(c) at least one converged IP communication unit, wherein the server downloads at least one management policy to one or more of the diverse IP networks based on at least one event associated with at least one of the converged IP communication unit and one or more of the diverse IP networks.

2. The all IP network of claim 1 wherein the management policy is downloaded based on the location of the converged IP communication unit.

3. The all IP network of claim 2 wherein the server extracts location information from the converged IP communication unit.

4. The all IP network of claim 2 wherein the converged IP communication unit sends location information to the server.

5. The all IP network of claim 1 wherein the management policy is downloaded based on information sent by the converged IP communication unit to the server.

6. The all IP network of claim 1 wherein the management policy is downloaded based on information extracted from the converged IP communication unit by the server.

7. The all IP network of claim 1 wherein the management policy is downloaded based on information sent by at least one of the diverse IP networks to the server.

8. The all IP network of claim 1 wherein the management policy is downloaded based on information extracted from at least one of the diverse IP networks by the server.

9. The all IP network of claim 1 wherein the management policy defines security and privacy criteria based on which of the diverse IP networks the converged IP communication unit is associated with.

10. The all IP network of claim 1 wherein the management policy defines a quality of service (QoS) or priority level based on which of the diverse IP networks the converged IP communication unit is associated with.

11. An all Internet protocol (IP) network comprising:
(a) a server including a management policy database;
(b) a plurality of diverse IP networks; and
(c) at least one converged IP communication unit, wherein the server downloads at least one management policy to the converged IP communication unit based on at least one event associated with at least one of the converged IP communication unit and one or more of the diverse IP networks.

12. The all IP network of claim 11 wherein the management policy is downloaded based on the location of the converged IP communication unit.

13. The all IP network of claim 12 wherein the server extracts location information from the converged IP communication unit.

14. The all IP network of claim 12 wherein the converged IP communication unit sends location information to the server.

15. The all IP network of claim 11 wherein the management policy is downloaded based on information sent by the converged IP communication unit to the server.

16. The all IP network of claim 11 wherein the management policy is downloaded based on information extracted from the converged IP communication unit by the server.

17. The all IP network of claim 11 wherein the management policy is downloaded based on information sent by at least one of the diverse IP networks to the server.

18. The all IP network of claim 11 wherein the management policy is downloaded based on information extracted from at least one of the diverse IP networks by the server.

19. The all IP network of claim 11 wherein the management policy is downloaded based on information extracted from at least one of the diverse IP networks by the server.

20. The all IP network of claim 11 wherein the management policy defines security and privacy criteria based on which of the diverse IP networks the converged IP communication unit is associated with.

21. An all Internet protocol (IP) network comprising:
(a) a server including a management policy database;
(b) a plurality of diverse IP networks; and
(c) at least one converged IP communication unit, wherein the server downloads a plurality of different management policies to respective ones of the diverse IP networks and the converged IP communication unit based on events associated with the converged IP communication unit and the diverse IP networks.

22. The all IP network of claim 21 wherein the management policies are downloaded based on the location of the converged IP communication unit.

23. The all IP network of claim 22 wherein the server extracts location information from the converged IP communication unit.

24. The all IP network of claim 22 wherein the converged IP communication unit sends location information to the server.

25. The all IP network of claim 21 wherein the management policies are downloaded based on information sent by the converged IP communication unit to the server.

26. The all IP network of claim 21 wherein the management policies are downloaded based on information extracted from the converged IP communication unit by the server.

27. The all IP network of claim 21 wherein the management policies are downloaded based on information sent by at least one of the diverse IP networks to the server.

28. The all IP network of claim 21 wherein the management policies are downloaded based on information extracted from at least one of the diverse IP networks by the server.

29. The all IP network of claim 21 wherein the management policy is downloaded based on information extracted from at least one of the diverse IP networks by the server.

30. The all IP network of claim 21 wherein the management policy defines security and privacy criteria based on which of the diverse IP networks the converged IP communication unit is associated with.
